(19) United States
(12) Patent Application Publication
(10) Pub. No.: US 2024/0392138 A1
(43) Pub. Date: Nov. 28, 2024

(54) CURING COMPOSITIONS FOR EPOXY RESIN COMPOSITIONS

(71) Applicant: MOMENTIVE PERFORMANCE MATERIALS GMBH, Leverkusen (DE)

(72) Inventor: Dmitry CHERNYSHOV, Rimpar (DE)

(21) Appl. No.: 18/713,887

(22) PCT Filed: Nov. 29, 2022
(86) PCT No.: PCT/EP2022/083586

§ 371 Date: May 28, 2024

(30) Foreign Application Priority Data
Nov. 30, 2021 (EP) 21211291.6

(51) Int. Cl. C09D 5/08; C08G 59/50; C08G 59/68; C08K 5/5425; C08K 5/5455; C09D 7/63; C09D 163/00

(52) U.S. Cl. CPC C09D 5/086; C08G 59/50; C08G 59/688; C08K 5/5425; C08K 5/5455; C09D 7/63; C09D 163/00

(57) ABSTRACT

The present invention relates to a curable epoxy resin composition comprising at least one epoxy resin, at least one epoxy resin curing agent, in particular selected from polyamines, and at least one silane selected from the group consisting of (meth)acrylamidoalkylsilanes, cyanoalkyl silanes and a combination of at least one (meth)acrylalkylsilane and at least one phosphine oxide compound, improved, in particular, waterborne epoxy resin coating compositions comprising the same, a kit of an epoxy resin composition and the curing composition, cured articles articles made from the epoxy resin compositions, in particular, coatings, and the use of the epoxy resin compositions for the manufacture of various industrial goods.

### DESCRIPTION

The present invention relates to curable epoxy resin compositions comprising a “composition (B)” (or “curing composition (B)” or also simply “curing composition”), comprising (i) at least one epoxy resin curing agent, preferably selected from polyamines, and (ii) at least one silane component. The silane component (ii) is selected from the group consisting of (meth)acrylamidoalkylsilanes, cyanoalkyl silanes and a combination of at least one (meth)acrylalkylsilane and at least one phosphine oxide compound. The invention further relates to improved, in particular, waterborne, curable epoxy resin coating compositions comprising said curing composition (B), a kit (or two-component composition) of an epoxy resin composition (A) and the curing composition (B), cured articles articles made from these curable epoxy resin compositions, in particular, coatings, and the use of these epoxy resin compositions for the manufacture of various industrial goods. The curing compositions (B) have improved shelf-life and provide epoxy resin compositions, in particular, epoxy resin coatings with improved wet adhesions and corrosion resistance on metal substrates such as steel. In addition, the curing compositions (B) used according to the invention do not lose their ability to provide the improved anticorrosion activity even after aging for 2-3 months at 50° C. in the manufacture of the curable epoxy resin coating compositions.

Typically, a two-component, water-based epoxy coating underperform in corrosion resistance compared with solvent-borne systems. Tightening of regulatory specifications require the industry to switch most of the paint processes to water-based platform technologies. Organofunctional silanes are known to be highly efficient adhesion/corrosion promoters for the two-component water-based epoxy coating formulations. While the incorporation of organofunctional silanes into the epoxy pigment part of a coating formulation allows epoxy coatings with improved wet adhesion and corrosion resistance, it is known from WO14019657A1 that such systems lack shelf life stability due to the premature hydrolysis of the silane and its consecutive condensation and consumption by the pigments and fillers present in the epoxy coating formulation. Thus, there is presently a need to provide silane-modified, corrosion resistant, two-component, water-based coating systems with extended wet paint shelf life. JP 42201100B2 (JP2000221779A), CN112300616A, CN104231866A, CN105131786A, and CN105131786A teach various organofunctional silanes and their hydrolyzed derivatives as adhesion promotors and anticorrosion additives for water-based-epoxide systems. However, no information regarding the activity of organofunctional silanes as adhesion promoters after aging is provided.

DE 102018130005 A1 discloses a UV-curing material which is liquid at room temperature, in particular for forming a potting frame (5) and/or a protective layer and/or a bridge and/or for use in the fixing of electrical and electronic components (3), comprising: at least one monomeric, radiation-curing compound (A); at least one photoinitiator (B); at least one prepolymer (C) having free isocyanate groups or free silane groups; and further additives (D), wherein the additives (D) comprise at least one aliphatic, aromatic and/or heterocyclic, primary, secondary and/or tertiary amine coordinatedly fixed in a cluster, characterized in that the additives (D) have at least one flame retardant, preferably a phosphorus-based flame retardant. The radiation-curing compound (A) is formed on the basis of (meth)acrylates, the further additives (D) comprising at least one (meth)acrylate oligomer. There is no disclosure of curable epoxy resin composition comprising at least one epoxy resin, at least one epoxy resin curing agent and at least one silane component selected from the group consisting of (meth)acrylamidoalkylsilanes, cyanoalkylsilanes and a combination of at least one (meth)acryloxyalkylsilane and at least one phosphine oxide compound, and the document also does not deal with problems of curable epoxy resin compositions.

EP 3685989 A1 relates to a resin composition that is used in a method for producing a three-dimensional shaped object comprising a cured product of the resin composition by selectively irradiating the liquid resin composition with an active energy ray, comprising:
a photocurable compound; and
metal-containing particles that are detectable by a metal detector and are surface-treated with a surface treating agent,
wherein a content of the metal-containing particles is 10 mass % or more and 55 mass % or less based on a solid content of the resin composition. EP 3685989 A1 discloses that (meth)acryloxyalkylsilane can be used for preparing metal-containing particles, but does not disclose any composition which comprises a (meth)acryloxyalkylsilane together with an epoxy resin curing agent and also does not deal with problems of curable epoxy resin compositions. U.S. Pat. No. 20,181,55571 A relates to a composition comprising a compound preparable by reaction of components comprising a polyethylenimine (PEI) and at least one an amine-reactive hydrolyzable organosilane to provide a reasonably stable one-part curable PEI-derived composition that can be applied to a substrate and cured.

The present invention has the object of providing curable epoxy resin compositions, in particular polyamine-based or polyamine-containing curable epoxy resin compositions, having improved shelf-life and which are capable of providing cured epoxy resin compositions in particular epoxy resin coatings with improved wet adhesions and corrosion resistance on metal substrates such as steel. In the manufacture of the epoxy resin compositions the curing compositions shall not lose their ability to provide the improved anticorrosion activity even after aging.

Thus, in accordance with the present invention there is provided curable epoxy resin composition comprising at least one epoxy resin and at least one composition (B) comprising (i) at least one epoxy resin curing agent, and (ii) at least one silane component selected from the group consisting of (meth)acrylamidoalkylsilanes, cyanoalkylsilanes and a combination of at least one (meth) acryloxyalkylsilane and at least one phosphine oxide compound.

In the curable epoxy resin composition according to the invention the epoxy resin curing agent is at least one organic compound that by virtue of the presence of two or more epoxy-group reactive functional groups, such as, in particular, amino groups, can react with an epoxy resin which is a polyepoxide compound, thereby leading to a cured epoxy resin product, as is well-known by the skilled person in the art (see e.g. Ha Q. Pham, Maurice J. Marks, Epoxy Resins, Ullmann's Encyclopedia of Industrial Chemistry 2005, which is incorporated by reference in its entirety herein).

The epoxy resin curing agent (i) is selected, in particular, from the group consisting of polyamines, such as polyfunctional, primary or secondary amines, such as aliphatic polyamines and adducts thereof, cycloaliphatic polyamines, aromatic polyamines, and amidopolyamines.

Preferably the epoxy resin curing agent (i) is selected from e.g.:
liquid (at room temperature (23° C.)) aliphatic polyamines such as polyethylene polyamines (PEPAs), and adducts with epoxy resins (resin adducts), carboxylic acids (polyamides, amidoamines), ketones (ketimines), and phenols/formaldehyde (Mannich bases),
in particular, aliphatic polyamines such as: longer chain alkylenediamines such as hexamethylenediamine (HMD), diethylenetriamine (DETA), and ethylene oxide reaction products thereof, such as e.g.

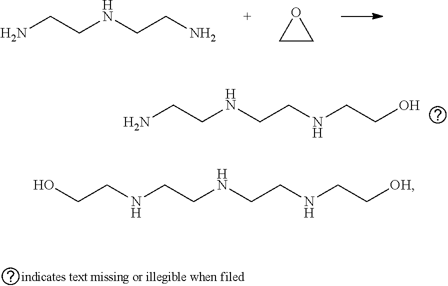

triethylenetetramine (TETA):

NH₂CH₂CH₂NHCH₂CH₂NHCH₂CH₂NH₂.

polyetheramines produced by reacting polyols derived from ethylene oxide or propylene oxide with amines, such as different molecular weight so-called JEFFAMINEs®, e.g. poly (oxypropylene diamines), such as those of the formula:

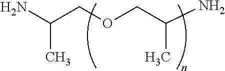

with n in this formula being an average number of up to 100,
poly(oxypropylene triamine), such as those of the formula:

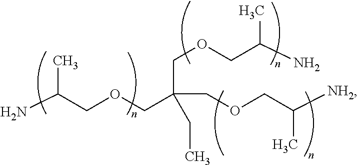

with n in this formula being an average number of up to 100,
poly(glycol amine) such as of the formula:

NH₂(CH₂)₃O(CH₂)₂O(CH₂)₃NHₑ,

### N-aminoethylpiperazine (AEP):

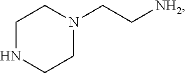

Cycloaliphatic polyamines, such as:
   isophorone diamine (IPDA):

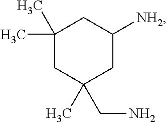

1,2-diaminocyclohexane (DACH):

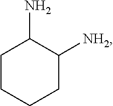

bis(4-aminocyclohexyl)methane (PACM):

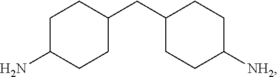 [SMILES: NC1CCC(CC2CCC(N)CC2)CC1]

Aromatic polyamines, such as:
   4,4′-diamino-diphenylmethane (MDA, DDM):

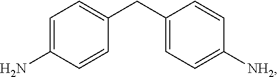 [SMILES: Nc1ccc(Cc2ccc(N)cc2)cc1]

4,4′-diaminodiphenyl sulfone (4,4′-DDS):

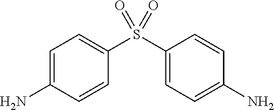 [SMILES: Nc1ccc(S(=O)(=O)c2ccc(N)cc2)cc1]

m-phenylenediamine (MPD):

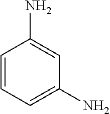

diethyltoluenediamine (DETDA) (including the isomers):

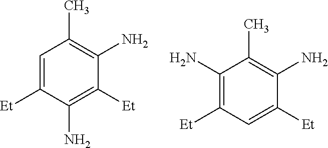

Resinous adducts of an excess diamine with epoxy resins (schematically shown as follows:

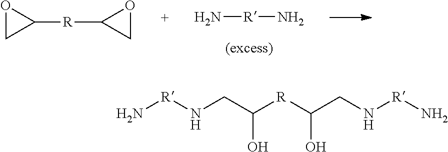

with R, R′ in these formulas being organic residues,
Blocked amines such as ketimines,
Mixtures of isophorone diamine (IPDA) with trimethylhexamethylenediamines (TMDA) or meta-xylenediamine (MXDA),
Arylyl Amines, such as (benzylic amines and hydrogenated derivatives) e.g. meta-Xylylene diamine (MXDA)

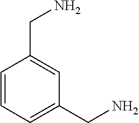

and its hydrogenated product, 1,3-bis(arninomethyl cyclohexane) (1,3-BAC),

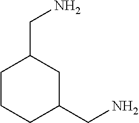

polyaminoamides such as those prepared by the reaction of dimerized and trimerized vegetable oil fatty acids with polyamines, where dimer acid is made e.g. by a Diels-Alder reaction between 9,12-and 9,11-linoleic acids:

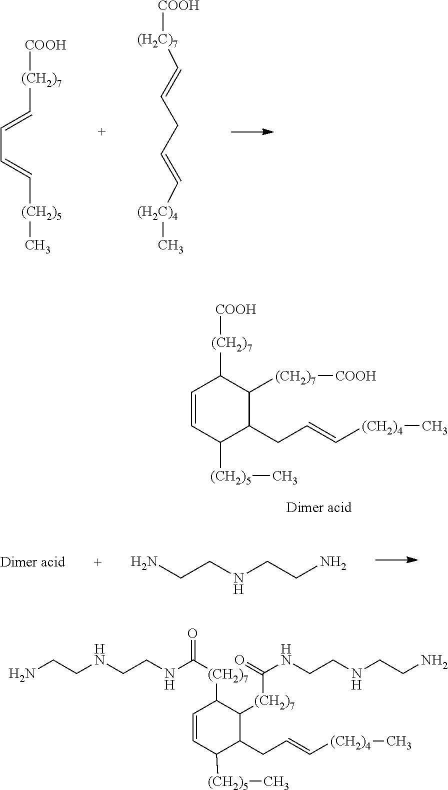

Amidoamines (prepared e.g. by the reaction of a monofunctional acid like tall-oil fatty acid with a multifunctional amine such as DETA, resulting in a mixture of amidoamines and imidazolines):

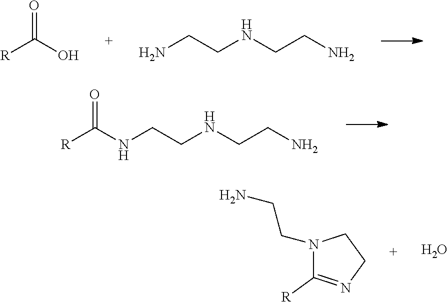

where R in this formula represents a fatty acid residue,
Dicyandiamide:

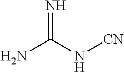

linear aminoalkyl-terminated polydiorganosiloxanes, such as those of the general formula:

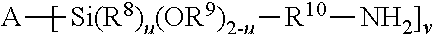

wherein
A is oxygen (—O—) or a polyorganosiloxanyl residue comprising at least one siloxy unit selected from the group consisting of R¹¹₃SiO_{1/2}, R¹¹₂SiO_{2/2}, R¹¹SiO_{3/2} and SiO_{4/2}, wherein R¹¹ is an organic group, preferably methyl, and the polyorganosiloxanyl residue is bonded to Si via an oxygen atom, with the provisos that (i) if A is oxygen (—O—), then v is 2, and (ii) if A is a polyorganosiloxanyl residue, then the polyorganosiloxanyl residue contains at least two siloxy groups which can bond to the silicon atom;
each R¹⁰ is independently selected from the group consisting of a straight chain divalent alkylene group having from 1 to 10 carbon atoms, branched chain divalent alkylene group having from 3 to 10 carbon atoms, a divalent cycloalkylene group having from 3 to 10 carbon atom, a divalent arylene group having from 6 to 12 carbon atoms, an divalent aralkylene group having from 7 to 10 carbon atoms and a divalent arenylene group having from 7 to 10 carbon atom, preferably methylene, propylene, 2-methylbutylene and 2,2-dimethylbutylene and more preferable a branched chain alkylene group having from 3 to 10 carbon atoms, such as 2,2-dimethylbutylene bound in particular to the Si and N atoms as shown schematically below:

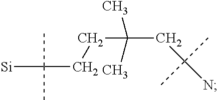

each R⁸ and R⁹ is independently selected from the group consisting of a straight chain alkyl group of from 1 to 10 carbon atoms, a branched chain alkyl group having from 3 to 10 carbon atoms and a cycloalkyl group having from 3 to 10 carbon atoms;
u is an integer independently 0 or 1 or 2, preferably x is 0 or 2; and
v is an integer independently from 2 to 8, preferably 2, 3 or 4, and more preferably 2.

A preferred amine is of the formula

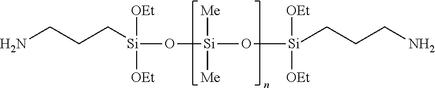

where in this formula n is an integer in the range from 0 to 2000, preferably 1 to 2000, more preferably 2 to 2000, still more preferably 0 to 100, still more preferably 0 to 50, still more preferably 1 to 100, still more preferably 1 to 50. Examples of those amines are disclosed e.g. in WO2020/079097, which is incorporated by reference in its entirety herein, as intermediate products,
   and mixtures of the above indicated polyamines.

A representative list of preferred possible polyamine curing agents includes in particular the following polyamines:
N-(3-aminopropyl) cyclohexylamine (APCHA),

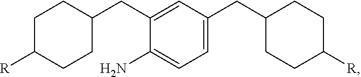

where R is NH₂,
polyether diamines, saturated aliphatic ring diamines, a linear aliphatic amines, cycloaliphatic amines, polycycloaliphatic amines, aromatic amines, and combinations thereof such as aliphatic polyamine such as diethylenetriamine (DETA), triethylenetetramine (TETA), tetraethylenepentamine (TEPA), pentaethylenehexamine (PEHA), hexamethylenediamine (HMDA), N-(2-aminoethyl)-1,3-propanediamine (N3-Amine), N,N′-1,2-ethanediylbis-1,3-propanediamine (N4-amine), or dipropylenetriamine; arylaliphatic polyamines such as m-xylylenediamine (mXDA), or p-xylylenediamine; cycloaliphatic polyamines such as 1,3-bisaminomethyl cyclohexane (1,3-BAC), isophorone diamine (IPDA), 4,4′-methylene bis cyclohexylamine (PACM), 1,2-diamino cyclohexane, or 4,4′-methylenebis-(2-methylcyclohexyl-amine); aromatic polyamines such as m-phenylenediamine, diaminodiphenylmethane (DOM), or diaminodiphenylsulfone (DOS); heterocyclic polyamines such as N-aminoethylpiperazine (NAEP), or 3,9-bis (3-aminopropyl) 2,4,8,10-tetraoxaspiro(5,5) undecane; polyalkoxypolyamines where the alkoxy group can be an oxyethylene, oxypropylene, oxy-1,2-butylene, oxy-1,4-butylene or co-polymers thereof such as 4,7-dioxadecane-1,10-diamine, 1-propanamine, 3,3′-(oxybis (2,1-ethanediyloxy)), bis(diaminopropylated diethylene glycol (ANCAMINE® 1922A), poly(oxy(methyl-1,2-ethanediyl)), alpha-(2-aminomethylethyl) omega-(2-aminomethylethoxy) (JEFFAMINE® D230, D-400), triethyleneglycoldiamine and oligomers (JEFFAMINER XT J-504, JEFFAMINE® XT J-512), poly(oxy(methyl-1,2-ethanediyl)), alpha,alpha′-(oxydi-2,1-ethanediyl)bis(omega(aminomethylethoxy)) (JEFFAMINE® XT J-511), bis(3-aminopropyl)polytetrahydrofuran 350, bis(3-aminopropyl) polytetrahydrofuran 750, poly(oxy(methyl-1,2-ethanediyl)), α-hydro-ω-(2-aminomethylethoxy)ether with 2-ethyl-2-(hydroxymethyl)-1,3-propanediol (3:1) (JEFFAMINE® T-403), and diaminopropyl dipropylene glycol. Particularly suitable polyamines include isophoronediamine (IPDA), 4,4′(PACM), 3,3′-dimethyl PACM (ANCAMINE® 2049), N-aminoethylpiperazine (NAEP), 4,7-dioxadecane-1,10-diamine, 1 propanamine, 3,3(oxybis(2,1-ethanediyloxy))bis(diaminopropylated diethylene glycol ANCAMINE 1922A), poly(oxy(methyl-1,2-ethanediyl)), alpha-(2-aminomethylethyl)omega-(2-aminomethylethoxy) (JEFFAMINE® D 230, D-400), poly(propylene glycol)bis(2-aminopropyl ether), triethylene glycol diamine (JEFFAMINE® XT J-504), and poly(oxy(methyl-1,2-ethanediyl))alpha,alpha′-(oxy(di-2 1-ethanediyl))bis(omega-(aminomethylethoxy)) (JEFFAMINE® XT J-511) or mixtures thereof.

Suitable commercially available polyamine epoxy curing agents include in particular, those of the Epikure®-type Hexion such as:
Aliphatic amines: Epikure® 3200 (aminoethylpiperazine). Epikure® 3223 (diethylenetriamine). Epikure® 3234 (triethylenetetramine). Epikure® 3245 (tetraethylenepentamine). Epikure® 3204 (solvent-free, flexible amine curing agent. Epikure® 3230 (a difunctional primary amine curing agent). Epikure® 3233 (trifunctional primary amine curing agent). Epikure® 3251 (Mannich curing agent designed for lower temperature, high humidity applications). Epikure® 3253 (accelerator for amine cured epoxy systems and for epoxy and urethane polymerizations). Epikure® 3270 (high reactivity curing agent for blush-free films, Epikure® 3271, Epikure®3272 (modified aliphatic amine epoxy curing agent), Epikure® 3273, Epikure® 3274, Epikure®3 277, Epikure® 3282 (reactive modified aliphatic amine adduct), Epikure® 3289 (reactive modified aliphatic amine), Epikure® 3290 (aliphatic amine), Epikure® 3295; Epikure® 3055. Epikure® 3055, Epikure® 3061, Epikure® 3072, Epikure® 3090,
Amidoamines, such as Epikure® 3010, Epikure® 3015, Epikure® 3030, Epikure® 3046,
Cycloaliphatic amines, such as Epikure® LY 3801, Epikure® 580 (low viscosity modified cycloaliphatic amine curing agent with no Benzylic Alcohol). Epikure® 3300, Epikure® 3370, Epikure® 3378, Epikure® 3380, Epikure® 3381, Epikure® 3382, Epikure® 3383, Epikure® 3387, Epikure® 3388, and Epikure® 3393,
Polyamides such as Epikure® 3100-ET-60, Epikure® 3115, Epikure® 3115-E-73, Epikure® 3115-X-70, Epikure® 3125, Epikure® 3140, Epikure® 3155, Epikure® 3164, Epikure® 3175, Epikure® 3180-F-75, and
Waterborne polyamines, such Epikure® 6870-W-53, Epikure® 8290-Y-60, Epikure® 8530-W-75, Epikure® 8535-W-50. Epikure® 8536-MY-60, Epikure® 8537-WY-60. Epikure® 8539-W-75, Epikure® 8540-MU-60.

The above-mentioned polyamines can be used alone or in combination thereof.

The content of the epoxy curing agent(s) in the curing composition (B) of the invention is preferably from about 5 to about 90 wt.-%, more preferably from about 15 to about 85 wt,-%, and still more preferably from about 30 to about 80 wt.-%, the percentages being each based on the total of all epoxy curing agents and the total amount of the composition.

The composition (B) used according to the invention is preferably comprising water, that is, it is preferably an aqueous or waterborne curing composition and also preferably applied with waterborne epoxy resin compositions. The water content in the curing composition (B) of the invention is preferably at least about 5 wt.-% or at least about 10 wt.-%, more preferably from about 5 to about 60 wt,-%, and still more preferably from about 10 to about 50 wt.-%, the percentages being each based on the total amount of the composition.

The composition (B) used according to the invention in a particular preferred embodiment is substantially free of inorganic particles, including fillers, pigments and/or extenders, because it has been found out that the presence of those inorganic particles may have a negative impact on the effect of the silane component (ii) added possibly through the interaction at the surface of such inorganic particles. According to the invention the term “substantially free of inorganic particles”, however, generally does not exclude the presence of small amounts of inorganic particles that do not have a detrimental impact on the effect of the silane added. For example, 1 wt.-% or less, preferably 0.5 wt.-% or less, more preferably 0.1 wt.-% or less based on the total of the curing composition of such inorganic particles might be tolerable. In another embodiment, the composition (B) is completely free of inorganic particles.

In the curing composition (B) used according to the invention in the silane component (ii) the (meth)acrylamidoalkylsilanes are preferably selected from the formula:

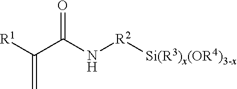

wherein R¹ is H or methyl, preferably methyl,
R² is a divalent C1-C6 alkylene group, that is, a divalent C1 to C6 alkanediyl group, such as preferably a propane-1,3-diyl group (—CH₂—CH₂—CH₂—), an ethan-1,2-diyl group (—CH₂—CH₂—) or a methylene group (—CH₂—), most preferably a propane-1,3-diyl group (—CH₂—CH₂—CH₂—),
R³ is a C1-C6 alkyl group, such as methyl, ethyl, propyl, isopropyl, n-butyl, isobutyl, sec-butyl, tert-butyl, n-pentyl, isopentyl, n-hexyl, etc. preferably methyl or ethyl,
R⁴ is a C1-C6 alkyl group as defined for R³, preferably methyl or ethyl,
x is 0-1, preferably 0, and particularly preferred the (meth)acrylamidoalkylsilane is the methacrylamidoalkylsilane selected from the formula:

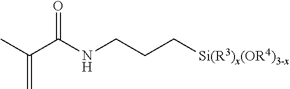

wherein x is preferably 0, and R⁴ is selected from methyl and ethyl;
the cyanoalkyl silanes are preferably selected from formula:

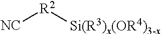

wherein R², R³ R⁴ and x are as defined before, with R² being preferably an ethane-1,2-diyl (—CH₂—CH₂—) group, and particularly preferred is a cyanoalkyl silane of the formula:

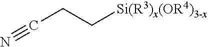

wherein x is preferably 0, and R⁴ is selected from methyl and ethyl, preferably R⁴ is methyl, and
the (meth)acryloxyalkylsilanes (used with the at least one phosphine oxide compound) are preferably selected from the formula:

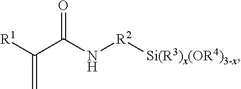

wherein R¹, R², R³ R⁴ and x are as defined before, with R² being preferably a propane-1,3-diyl (—CH₂—CH₂—CH₂—) group, and particularly preferred the (meth)acryloxyalkylsilane is a methacryloxyalkylsilane of the formula:

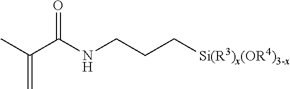

wherein x is preferably 0, and R⁴ is selected from methyl and ethyl,
and the mixtures of such silanes (and the at least one phosphine oxide compound, in case the silane includes the (meth)acryloxyalkylsilane).

The amount of such silanes in the curing composition (B) used in the invention is preferably from about 0.1 to about 25 wt.-% more preferably from about 0.5 to about 20 wt.-%, based on the total amount of the curing composition.

In the curing composition (B) used according to the invention the at least one (meth)acryloxyalkylsilane is used in combination with at least one phosphine oxide compound. Preferably the phosphine oxide compound is of the formula:

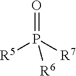

wherein R⁵, R⁶ and R⁷ are selected from optionally substituted aryl groups, linear or branched C1-C10 alkoxy groups, and optionally substituted acyl groups, and where up to one of R⁵, R⁶ and R⁷ can be hydroxy.

Optionally substituted aryl may include monocyclic or fused aryl groups. Representative aryl groups include phenyl, naphthyl and biphenyl. Other aryl groups include benzyl, having a methylene linking group. The aryl groups can be optionally substituted with one or more moieties selected from alkyl, alkenyl, alkynyl, haloalkyl, halo, hydroxy, amino, alkylamino, alkoxy, haloalkyl, carboxy, alkyl carboxylate, amido, nitro, oxo, and cyano. Particular preferred is phenyl, optionally substituted with one or more alkyl groups.

Linear or branched C1-C10 alkoxy may include linear or branched C1 to C10 alkoxy groups such as, for example, methoxy, ethoxy, propoxy, iso-propoxy, butoxy, 2-butoxy, iso-butoxy, sec-butoxy, tert-butoxy, pentoxy, hexoxy, 2-ethylhexoxy etc.

Optionally substituted acyl a moiety —C(O)R, wherein R in this formula may be an aliphatic or aromatic group) such as aroyl, such as optionally substituted benzoyl, where it can be referred with respect to the optional substituents to those for aryl indicated above.

Up to one of the total of the residues R⁵, R⁶ and R⁷ can be hydroxy. The phosphine oxide compounds as used in the present invention may thus also include diorgano hydrogen phosphate compounds (of the type O═P(OR)₂OH, where in this formula R is an organic group).

The phosphine oxide compounds used in accordance with the invention include preferably conventional phosphine oxide photoinitiators such as those described in WO2021/176021 A1 or WO2021/176023 A1 (incorporated by reference as regards the photoinitiators disclosed therein), and particularly preferred are e.g. 2,4,6-Trimethylbenzoyl-ethoxy-phenyl-phosphine oxide (TPO-L):

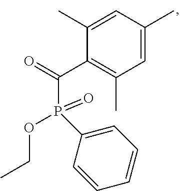 [SMILES: CCOP(=O)(C(=O)c1c(C)cc(C)cc1C)c1ccccc1]

TPO (Diphenyl-(2,4,6-trimethylbenzoyl)-phosphinoxide)

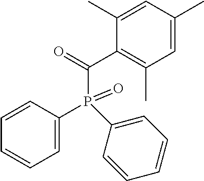 [SMILES: Cc1cc(C)c(C(=O)P(=O)(c2ccccc2)c2ccccc2)c(C)c1]

or
bis(2-ethylhexyl) phosphate:

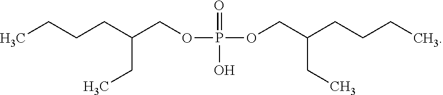 [SMILES: CCCCC(CC)COP(=O)(O)OCC(CC)CCCC]

The phosphine oxide compounds are preferably used in a wt.-ratio of the (meth)acryloxyalkylsilane to the phosphine oxide compound of about 5:1 to about 1:5, preferably about 4:1 to about 1:4, more preferably about 3:1 to about 1:3. The content of the phosphine oxide compounds in the composition is preferably about 0.1 to about 20 wt.-%, more preferably about 0.5 to about 18 wt.-% based on the total amount of the composition.

The curing composition (B) used according to the invention preferably comprises:
about 30 to about 85 wt.-%, more preferably about 45 to about 80 wt.-%, still more preferably about 50 to about 75 wt.-% of the epoxy curing agent(s), that is, the total of the epoxy curing agents, if more than one epoxy curing agent is present,
about 5 to about 60 wt.-%, more preferably about 10 to about 50 wt.-%, still more preferably about 15 to about 45 wt.-% of water and/or diluents, i.e. the total of all diluents and water, and about 0.1 to about 20 wt.-% more preferably about 0.5 to about 15 wt.-% of the at least one silane as defined above, or the combination of at least one (meth)acryloxyalkylsilane and at least one phosphine oxide compound (again relating to the total of the said silanes if a plurality of the silanes is present),
wherein the weight percentages are based on the total amount of the composition.

The present invention in a further aspect relates to the use of the curing composition (B) as a curing agent for epoxy resins, preferably for water-based or waterborne epoxy resin compositions.

The present invention in a further aspect relates to the use of the curing composition (B) for the manufacture of a curable epoxy-resin composition.

The present invention relates to a curable epoxy resin composition comprising at least one epoxy resin and at least one curing composition (composition (B)) according to the invention, comprising the at least one epoxy resin curing agent, as defined above.

Said curable epoxy-resin composition according to the invention is preferably also an aqueous resin composition, that is, it comprises water in a certain amount of usually at least about 5 weight percent, preferably at least about 10 weight percent based on the total composition of the curable epoxy resin composition.

The inventive, preferably aqueous, curable epoxy-resin composition according to the invention is preferably selected from, in particular, a coating composition, a painting composition, an adhesive composition, an encapsulant composition, a sealant composition, a composite material composition, such as a fiber-reinforced composition, and preferably the epoxy resin composition is a coating composition, more preferably an aqueous or waterborne coating composition.

The inventive curable epoxy resin composition is usually provided as a curable two (or more)—component resin composition (or a kit of two and possibly more parts) comprising, separately, a first part (A), which is a composition comprising the at least one epoxy resin to be cured, and a second part (B), i.e. the curing composition (B) used according to the invention, as defined before.

The present invention thus relates in a further aspect, in particular, to a kit of parts comprising a first part (A), that is, a composition comprising the at least one epoxy resin, and a second part (B), which is the curing composition (B) used according to the invention comprising the at least one epoxy resin curing agent, said composition being as defined above.

In the curable epoxy resin composition or the kit of parts according to the invention the molar ratio of the total molar amount of epoxy groups in the one or more epoxy resins to the total molar amount of epoxy-reactive functional, in particular, amino groups, in the one or more curing agents is preferably from about 3:1 to about 1:1, more preferably from about 2:1 to about 1:1, that is, preferably the epoxy resins are used in an amount that there is a molar excess of epoxy groups compared to the epoxy-reactive functional, in particular, amino groups in the curing agent, which leads to good curing results.

The curable epoxy resin composition or the kit of parts (as a whole) according to the invention, preferably comprises:
about 5 to about 80 wt.-%, more preferably about 7 to about 70 wt.-%, still more preferably about 8 to about 60 wt.-%, still more preferably about 10 to about 50 wt.-% of the at least one epoxy resin, relating to the total of the epoxy resins if there are multiple epoxy resins,
about 5 to about 40 wt.-%, more preferably about 10 to about 30 wt.-% of the epoxy curing agent(s), again relating to the total of epoxy curing agents, if there is more than one epoxy curing agent,
about 5 to about 60 wt.-%, more preferably about 10 to about 50 wt.-% of water and/or diluents, in particular of water, the amounts again are based on the total of water and/or diluents,
about 0.1 to about 20 wt.-%, more preferably about 0.5 to about 15 wt.-% of the at least one silane component (ii) as defined above,
wherein the weight percentages are based on the total amount of the composition or the kit of parts.

In the epoxy resin composition or the kit of parts according to the invention the epoxy resin is preferably selected from the group of consisting of polyepoxides (i.e. organic compounds having more than one oxirane or oxacyclopropane groups

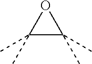

in the molecule (where the dotted lines each represent a single bond)), such as:
epoxy resins derived from epichlorohydrin (glycidyl-based resins) which are prepared by the coupling reaction of compounds containing at least two active hydrogen atoms (such as polyphenolic compounds, mono and diamines, amino phenols, heterocyclic imides and amides, aliphatic diols and polyols and dimeric fatty acids) with epichlorohydrin followed by dehydrohalonenation.

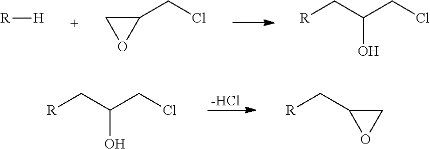

epoxy resins based on epoxidized aliphatic or cycloaliphatic dienes produced by direct epoxidation of olefins with peracids:

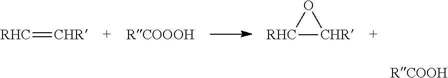

(wherein R′, R′ and R″ independently represent aliphatic and/or cycloaliphatic resins),
liquid (LER) and solid (SER) epoxy resins based on diglycidyl ether of bisphenol A, (DGEBA), that is, the reaction product of epichlorohydrin and bisphenol A:

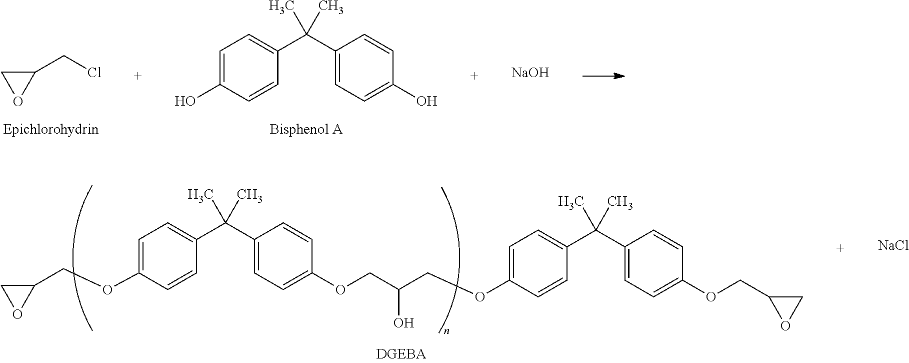

(where n in this formula is an average value of up to about 40, preferably up to 35, more preferably up to 30), such as type “1,” “2” to type “10” resins, such as SERs like D.E.R. 661, 662, 664, 667, 669 resins from Dow Chemical, and Epon 1001 to 1009 series from Resolution, having preferably a weight average molecular weight of up to 25000, and hydrogenated forms thereof based on:

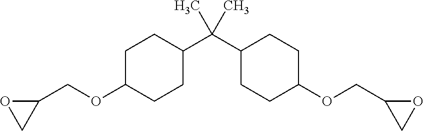 [SMILES: CC(C)(C1CCC(OCC2CO2)CC1)C1CCC(OCC2CO2)CC1]

Bisphenol F epoxy resins, based on the lowest MW member of the phenol novolacs, i.e. bisphenol F, which is prepared with a large excess of phenol to formaldehyde; where a mixture of o,o′, o,p′, and p,p′ isomers is obtained:

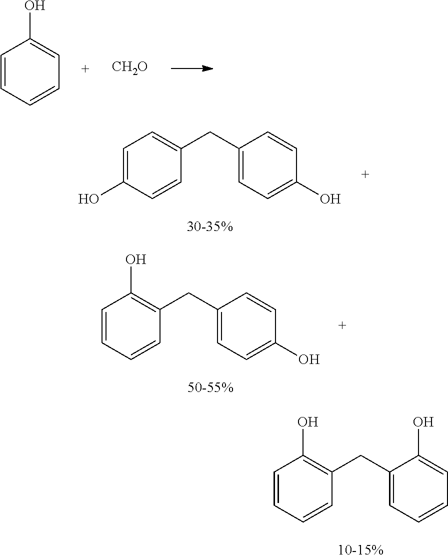

the reaction with epichlorohydrin yielding:

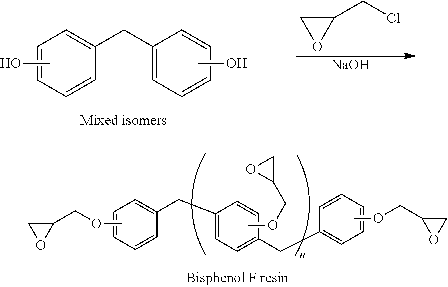

(where n in this formula is an average value of up to about 40, preferably up to 35, more preferably up to 30),
Multifunctional phenol epoxy novolac or creeol epoxy novolac reeins, such as.

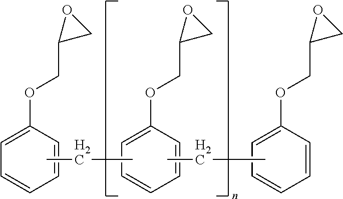

(with n in this formula usually being in the range from 0 to 4, and their various constitutional isomers), bisphenol A novolace such as

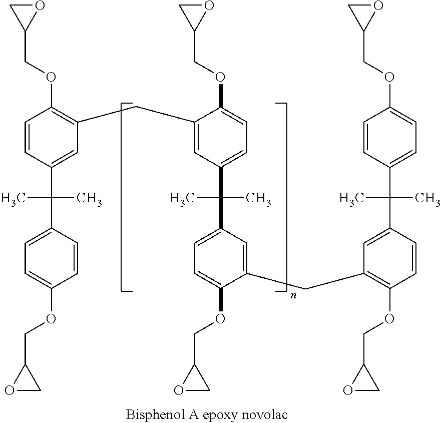

(with n in this formula usually being in the range from 0 to 4, and their various constitutional isomers),
other multifunctional epoxy resins, such as glycidyl ether derived resins, e.g. glycidyl ether of tetrakis (4-hydroxyphenyl) ethane:

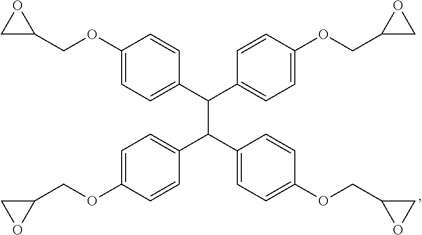 [SMILES: c1cc(C(c2ccc(OCC3CO3)cc2)C(c2ccc(OCC3CO3)cc2)c2ccc(OCC3CO3)cc2)ccc1OCC1CO1]

tris[4-(2,3-epoxypropoxy)phenyl] methane isomers,
Cycloaliphatic epoxy resins, such as

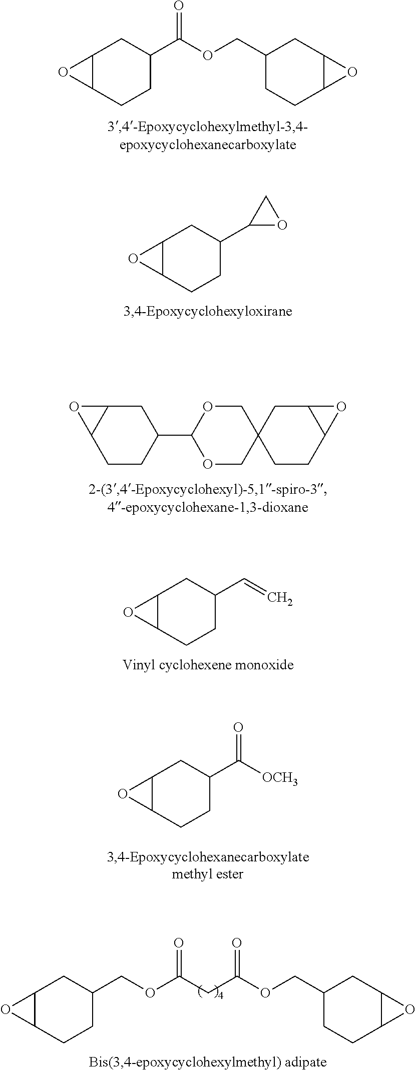

Halogenated such as in particular brominated and fluorinated epoxy resins, such as those based on tetrabromobisphenol A (TBBA)

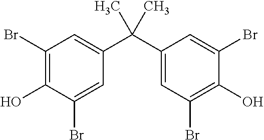 [SMILES: CC(C)(c1cc(Br)c(O)c(Br)c1)c1cc(Br)c(O)c(Br)c1]

or the diglycidyl ether of TBBA, 2,2-bis[3,5-dibromo-4-(2,3-epoxypropoxy)phenyl]propane:

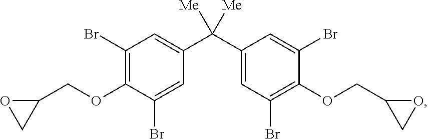 [SMILES: CC(C)(c1cc(Br)c(OCC2CO2)c(Br)c1)c1cc(Br)c(OCC2CO2)c(Br)c1]

such as

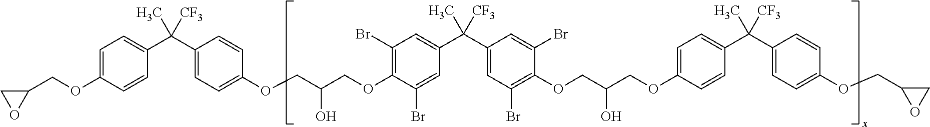

(x in this formula representing a suitable average value), or those based on

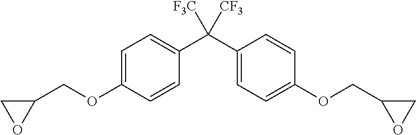 [SMILES: FC(F)(F)C(c1ccc(OCC2CO2)cc1)(c1ccc(OCC2CO2)cc1)C(F)(F)F]

epoxy resins diluents, typically formed by glycidylation of aliphatic alcohols or polyols, such as

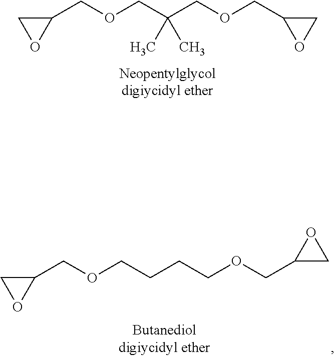

or those based on polyglycols of various chain lengthes such as:

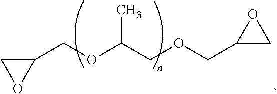

polyglycidyl ethers of polyols such as sorbitol, glycerol, and pentaerythritol, or monofunctional diluents which can be used in combination with polyepoxides such as

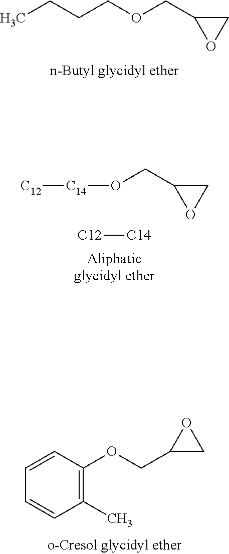

Glycidylamine epoxy resins formed from aromatic amines with epichlorohydrin, such as triglycidyl-p-aminophenol

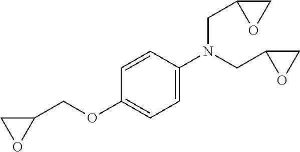 [SMILES: c1cc(N(CC2CO2)CC2CO2)ccc1OCC1CO1]

and N,N,N,N-tetraglycidyl-bis-(4-aminophenyl)-methane,

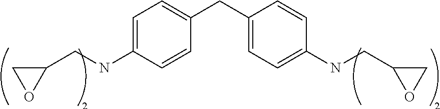

Crystalline epoxy resins such as those based on biphenol, such as those based on

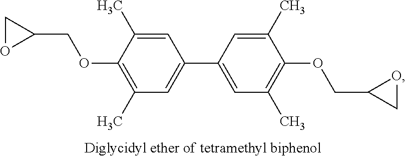 [SMILES: Cc1cc(-c2cc(C)c(OCC3CO3)c(C)c2)cc(C)c1OCC1CO1]

such as those based on dihydroxv naphthalenes such as

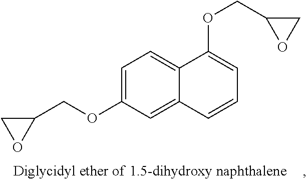 [SMILES: c1cc(OCC2CO2)c2ccc(OCC3CO3)cc2c1]

Heterocyclic epoxy resins such as those based on isocyanurate

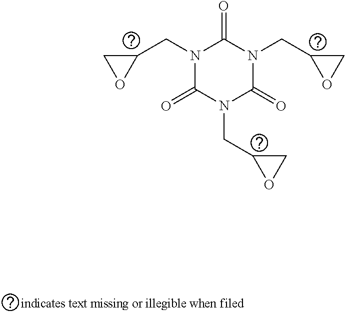 [SMILES: O=c1n(CC2CO2)c(=O)n(CC2CO2)c(=O)n1CC1CO1]

or hydantoin-based epoxy resins of the type

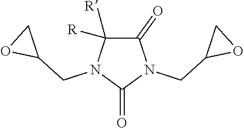

with R, R′ in this formula being organic preferably aliphatic residues or form a spiro-type bridge.
Glycidyl esters such as

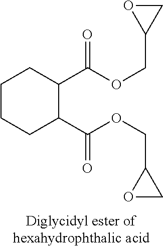 [SMILES: O=C(OCC1CO1)C1CCCCC1C(=O)OCC1CO1]

and the mixtures thereof.

The epoxy resin component can consist of a single resin, or it can be a mixture of two or more, preferably mutually compatible, epoxy resins.

A representative list of possible epoxy resins is shown in the following, but is not limited to, e.g. bifunctional epoxies, such as, bisphenol-A and bisphenol-F resins. Epoxide compounds are generally multifunctional polyepoxy resins, contain two or more 1,2-epoxy groups per molecule, and are well known to those of skill in the art. They are described for example in Y. Tanaka, “Synthesis and Characteristics of Epoxides”, in C. A. May, ed., Epoxy Resins Chemistry and Technology (Marcel Dekker, 1988), or ULLMANNS ENCYCLOPEDIA OF INDUSTRIAL CHEMISTRY, HA Q. PHAM, MAURICE J. MARKS, Epoxy Resins, which are each incorporated herein by reference in its entirety. Suitable preferred epoxy resins comprise e.g. the glycidyl ethers of polyhydric phenols, including the glycidyl ethers of dihydric phenols. Examples include the glycidyl ethers of: resorcinol, hydroquinone, bis-(4-hydroxy-3,5-difluorophenyl)-methane, 1,1-bis-(4-hydroxyphenyl) ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane (bisphenol A), bis-(4-hydroxyphenyl)-methane (bisphenol-F and which may contain varying amounts of 2-hydroxyphenyl isomers), and the like, or any combination thereof.

Additionally, dihydric phenols of the structure of the formula

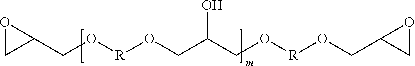

can be used, where m in this formula is an average value representing preferably 0 to 25, and R in this formula is a divalent hydrocarbon radical of a dihydric phenol, such as those dihydric phenols above, which can be prepared by polymerizing mixtures of a dihydric phenol and epichlorohydrin, or by reacting a mixture of a diglycidyl ether of the dihydric phenol and the dihydric phenol. The epoxy component may be also a polyglycidyl amine compounds based on 2,2′-methylene dianiline, 4,4′-methylene dianiline, m-xylene dianiline, hydantoin, and isocyanurate.

The epoxy resin component may be also a cycloaliphatic (alicyclic) epoxide. Examples of suitable cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, vinylcyclohexene diepoxides; limonene diepoxide; bis(3,4-epoxycyclohexylmethyl)pimelate; dicyclopentadiene diepoxide; and other suitable cycloaliphatic epoxides. Other suitable diepoxides of cycloaliphatic esters of dicarboxylic acids are described, for example, in WO 2009/089145 A1, which is hereby incorporated by reference. Other cycloaliphatic epoxides include 3,3-epoxycyclohexylmethyl-3,4-epoxycyclohexane carboxylate such as 3,4-epoxycyclohexylmethyl-3,4-epoxycyclohexane carboxylate; 3,3-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane, 3,4-epoxy-2-methylcyclohexyl-methyl-3,4-epoxy-3-methylcyclohexane carboxylate. Other suitable 3,4-epoxycyclohexylmentyl-3,4-epoxycyclohexane carboxylates are described, for example, in U.S. Pat. No. 2,890,194, which is hereby incorporated by reference. In other embodiments, the epoxy component may include polyol polyglycidyl ether from polyethylene glycol, polypropylene glycol or polytetrahydrofuran or combinations thereof. Also epoxy novolac resins, which are glycidyl ethers of novolac resins, can be used as multifunctional epoxy resins. Preferably the epoxy resin is the diglycidyl ether of bisphenol-A (DGEBA), higher molecular weight resins based on DGEBA, a diglycidyl ether of bisphenol-F, an epoxy novolac resin, or a combination thereof. Higher molecular weight versions or derivatives of DGEBA are prepared by the process, where excess DGEBA is reacted with bisphenol-A to yield epoxy terminated products. The epoxy equivalent weights (EEW) for such products preferably ranges from about 450 to about 3000 or more. DGEBA or higher molecular DGEBA resins are often used for structural formulations due to a combination of their low cost and generally high-performance properties. Commercial grades of DGEBA having an EEW ranging from about 174 to about 250, and more commonly from about 185 to about 195, are available. At the low molecular weights, the epoxy resins are liquids and are often referred to as liquid epoxy resins. Liquid epoxy resin are low molecular polymers, since pure DGEBA has an EEW of 174. Resins with EEW's between 250 and 450, are referred to as semi-solid epoxy resins because they are a mixture of solid and liquid at room temperature. Generally, multifunctional resins with EEW's based on solids of about 160 to about 750 are useful in the present disclosure. In another aspect, the multifunctional epoxy resin has an EEW in a range from about 170 to about 250. Depending upon the intended use, it can be beneficial to reduce the viscosity of the compositions by modifying the epoxy resin component with a monofunctional epoxide. Examples of monoepoxides include, but are not limited to, styrene oxide, cyclohexene oxide and the glycidyl ethers of phenol, cresols, tert-butylphenol, other alkyl phenols, butanol, 2-ethylhexanol, C4 to C14 alcohols, and the like, or combinations thereof. The epoxy resin can also be present in a solution or emulsion, with the diluent being water, an organic solvent, or a mixture thereof. Preferably the epoxy resin is used as an aqueous dispersion comprising water, and optionally an organic solvent optionally together other additives such as fillers, extenders and/or pigments in particular.

Particularly preferred are epoxy resins from Hexion, such as the EPI-REZ® Waterborne Epoxy Resins, EPIKOTE® Resins, EPONEX® Cycloaliphatic Epoxy Resin.

Further preferred waterborne epoxy resins are described e.g. by Adrian Thomas, in Surface Coatings International Issue 2016/3, Page 181, which is incorporated by reference in its entirety herein.

In a preferred embodiment of the invention the composition (A), comprising the at least one epoxy resin, comprises at least one kind of inorganic particles, such as pigments, fillers and/or extenders, and the composition (B), comprising the at least one epoxy resin curing agent, preferably is substantially free of inorganic particles such as pigments, fillers and/or extenders. Regarding the latter as stated above the composition (B) according to the invention in a particular preferred embodiment is substantially free of inorganic particles, including fillers, pigments and/or extenders, because it has been found out that the presence of those inorganic particles has a negative impact on the effect of the silane added through the interaction at the surface of the inorganic particles. According to the invention the term “substantially free of inorganic particles”, however, does not exclude the presence of small amounts of inorganic particles as long as they do not have a detrimental impact on the effect of the silane added. For example, about 1 wt.-% or less, preferably about 0.5 wt.-% or less, more preferably about 0.1 wt.-% or less based on the total of the composition of such inorganic particles might be tolerable in the composition (B). In another embodiment, the composition (B) is completely free of such inorganic particles.

In a preferred embodiment the curable epoxy resin composition or the kit of parts according to the invention comprises water. This means, in particular, that the preferred curable epoxy resin composition is a waterborne epoxy resin composition which comprises preferably at least about 1 weight percent water, in particular at least about 5 weight percent water, more preferably at least about 10 weight percent, and preferably the water content is about 1 to about 25% by weight, preferably about 1 to about 20% by weight, water based on the total amount of the curable epoxy resin composition or the kit-of-parts forming the same.

In a further preferred embodiment, the curable epoxy resin composition or the kit of parts according to the invention may comprise additional binder resins such as acrylic resins, and if so preferably in an amount of about 1 to about 10 weight percent based on the total composition.

In a further embodiment of the present invention it concerns also a process for the manufacture of the curable epoxy resin composition according to the invention comprising the step of admixing a composition (A), comprising at least one epoxy resin, and the composition (B) comprising the at least one epoxy resin curing agent as defined before. Conventional mixing apparatuses can be used for such purpose.

In said process the mixing weight ratio of the epoxy resin composition component (A) to the curing composition (B) is usually from about 10:1 to about 1:4, preferably 8:1 to about 1:2, more preferably about 6:1 to about 1:1.

The curable epoxy resin composition or the kit of parts according to the invention may optionally comprise one or more additives such as those selected from for example:
fillers or pigments, such as marble flour dolomitic (magnesium-calcium carbonate), chalk powder (precipitated carbonate), sand (quartz, feldspar and subsidiary materials), silica flour (ground silica), mica flour (muscovite), slate powder (slatea), vermiculite, phenolic phenolic microballoons, zircon flour, aluminum metallic powder, chopped low glass strands, hydrated alumina aluminum oxide, fiber glass,
reactive and nonreactive diluents, such as organic solvents and plasticizers such as alcohols, such as nonyl phenol, furfuryl alcohol, benzyl alcohol, 1-phenoxy-2-propanol and 1-methoxy-2-propanol and dibutyl phthalate,
extenders,
processing aids,
stabilizers,
surfactants,
defoamers,
air release agents,
viscosity modifiers, such as thixotropic agents such as colloidal silicas and bentonite clays or chemical additives,
UV absorbents,
flame retardants,
impact modifiers, including toughening agents and flexiblizers, and
flash rust inhibitors, etc.

As stated above any inorganic particles among these additives are preferably included in part (A), that is, the epoxy resin composition, and not in part (B), that is, the curing composition according to the invention which comprises the at least one epoxy resin curing agent as defined above.

Further representative preferred optional additives for the curable epoxy resin composition, in particular, the curable epoxy resin coating composition include non-reactive plasticizer(s), filler(s), processing aid(s), stabilizer, air release agent, viscosity modifier(s), UV absorbent agent, a flame retardant, and/or impact modifier. Optionally acrylates or methacrylate esters of polyols may be blended with the epoxy resin component. Preferably the curable epoxy resin compositions of the invention do not contain acrylates or methacrylates. Fillers or pigments are preferably added to the epoxy resin component not to the curing component containing the at least one silane. Such fillers or pigments may include but are not limited to multi-wall carbon or boron nitride nanotubes, single-wall carbon, carbon or boron nitride nanoparticles, carbon or boron nitride nanofibers, carbon or boron nitride nanoropes, carbon or boron nitride nano ribbons, nanoclays; nanoclays comprising tubules; layered inorganic clay material; talc; carbon black; cellulose fibers; silica; and alumina. Also reinforcing fibers may be included in the epoxy resin composition, such as fiberglass, carbon fiber, carbon nanotubes, nano composite fibers, polyaramide fibers, poly(p-phenylene benzobisoxazole) fiber, Aramid Kevlar fiber, ultrahigh molecular weight polyethylene fiber, high and low density polyethylene fibers, polypropylene fibers, nylon fibers, cellulose fibers, natural fibers, biodegradable fibers, and combinations thereof. Fibers include also organic or inorganic fibers, natural fibers or synthetic fibers, and may be present in the form of wovens or non-crimp fabrics, nonwovens webs or mats, and also in the form of fiber stands (rovings), or staple fiber formed of continuous or discontinuous fiber such as fiber glass, carbon fiber, carbon nanotubes, nano composite fibers, polyaramide fibers such as those sold under the trade name KEVLAR®, Poly(p-phenylene benzobisoxazole) fiber such as those sold under the trade name ZYLON®, ultrahigh molecular weight polyethylene fibers such as those sold under the trade name SPECTRA®, high and low density polyethylene fibers, polypropylene fibers, nylon fibers, cellulose fibers, natural fibers, biodegradable fibers and combinations thereof. Such fibers (woven or non-woven) can be coated with the solvent or solvent free epoxy resin mixture by the standard impregnating methods, in particular for filament winding (FW), pultrusion, sheet molding compound, bulk molding compound autoclave molding, resin infusion, vacuum assisted resin transfer molding (VARTM), resin transfer molding (RTM), wet/hand lay-up, vacuum bagging, resin impregnation, prepreg, fiber impregnation, compression molding (CM), brushing, spraying, or dipping, casting, injection molding or combination thereof.

The amount of the optional additives in the curable epoxy resin composition or the kit of parts (as a whole) can be for example more than about 1, preferably more than about 5, more preferably more than about 10 weight percent and for example up to about 50, preferably up to about 40 more preferably up to about 30 weight percent based on the total amount of the composition.

The present invention further relates to cured epoxy resin compositions obtained by curing the curable epoxy resin composition, comprising the composition (A) comprising at least one epoxy resin and the curing composition (B) of the invention. It is well-known to those skilled in the art that curing of the epoxy resins is usually effected by the reaction with curing agents having generally two or more functional epoxy group reactive-groups such as amino groups, in particular, leading to the cured epoxy resins.

Such cured epoxy compositions according to the invention are usually obtained by curing at a temperature in the range of 20 to 100° C.

Cured articles, comprising the cured epoxy resin composition according to the invention are preferably selected from components for the automotive industry, the construction industry, the marine industry, the aerospace industries, the electronic industry, such as coatings, paints, lacquer, adhesive layers, composites, encapsulants in particular for circuit boards and the like. Particular preferred the cured articles are coatings on metal substrates in particular steel substrates. Such coatings, which are layered materials usually have a dry thickness in the range of about 1 to about 100 μm, preferably about 55 to about 65 μm.

The present invention further relates to the use of the curable epoxy resin compositions according to the invention for the manufacture of marine and industrial maintenance coatings, metal container and coil coatings, automotive coatings, inks and resists, adhesive coatings, casting, potting, and encapsulation of electrical-equipment.

The present invention further relates to the use of the curable epoxy resin compositions according to the invention to prepare a layer of a multilayer coating, in particular, the base layer of the multilayer coating on a metal substrate, in particular, for the manufacture of primer layers on metal substrates, in particular, steel substrates.

The present invention further relates to the use of silanes, selected from the group consisting of (meth)acrylamidoalkylsilanes, cyanoalkyl silanes and a combination of at least one (meth)acryloxyalkylsilane and at least one phosphine oxide compound as corrosion inhibitor in epoxy resin compositions, in particular, epoxy resin coating compositions.

That is, in particular the present invention discloses a two-component, in particular water-based epoxy resin composition, in particular as a coating system, which is based on a part (A) and a part (B). Part (A) preferably contains a dispersion of inorganic particles such as fillers, pigments and/or extenders and the at least one polyepoxide resin, and part (B) is the crosslinker, in particular, polyamine crosslinker composition, which is modified with said silane component (ii) as defined above. The polyepoxide resins of the invention are particularly preferred water-based Type I (i.e. liquid or liquid emulsions type) epoxy solid bis-A resin dispersions, the polyamine crosslinkers are particularly preferred modified polyamine adduct dispersions and the organofunctional silane component (ii) is selected from (meth)acrylamidoalkylsilanes, cyanoalkylsilanes and a combination of at least one (meth)acryloxyalkylsilane and at least one phosphine oxide compound. The current invention demonstrates that usage of, in particular, cyanoethyltrialkoxysilanes and methacrylamidopropyltrialkoxysilanes as adhesion promoters or corrosion inhibitor respectively, added into the preferably water-based modified polyamine dispersion, allows to maintain, good storage stability combined with good adhesion and anticorrosion properties of the experimental coatings even after extended aging periods of the wet paint samples (e.g. minimum 1 month in accelerated aging test at 50° C.). It is a further subject of the current invention it is shown that combining (meth)acryloxyalkylsilane such as gamma-(methacryloxypropyl) trialkoxysilane with one or more phosphine oxide compounds such as radical photoinitiators demonstrate the same behavior.

It will be understood that any numerical range recited herein includes all sub-ranges within that range and any combination of the various endpoints of such ranges or sub-ranges, be it described in the examples or anywhere else in the specification.

It will also be understood herein that any of the components of the invention herein as they are described by any specific genus or species detailed in the examples section of the specification, can be used in one embodiment to define an alternative respective definition of any endpoint of a range elsewhere described in the specification with regard to that component, and can thus, in one non-limiting embodiment, be used to supplant such a range endpoint, elsewhere described.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

### PREFERRED EMBODIMENTS OF THE INVENTION

The preferred embodiments of the invention are summarized in the following:
1. A composition (B) comprising (i) at least one epoxy resin curing agent and (ii) at least one silane component selected from the group consisting of (meth)acrylamidoalkylsilanes, cyanoalkylsilanes and a combination of at least one (meth)acryloxyalkylsilane and at least one phosphine oxide compound.
2. The composition according to the previous embodiment, wherein the epoxy resin curing agent (i) is selected from the group of polyamines.
3. The composition according to any of the previous embodiments further comprising water.
4. The composition according to any of the previous embodiments, wherein the composition is substantially free of inorganic particles.
5. The composition according to any of the previous embodiments, wherein the (meth)acrylamidoalkylsilanes are selected from the formula:

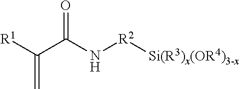

wherein R¹ is H or methyl,
R² is a divalent C1-C6 alkylene group,
R³ is a C1-C6 alkyl group, preferably methyl or ethyl,
R⁴ is a C1-C6 alkyl group, preferably methyl or ethyl,
x is 0-1, preferably 0,
   particularly preferred is

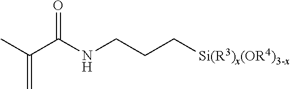

wherein x is preferably 0, and R⁴ is selected from methyl and ethyl,
the cyanoalkylsilanes are selected from formula:

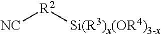

wherein R², R³ R⁴ and x are as defined above, R² is preferably a 1,2 ethane diyl group, particularly preferred is

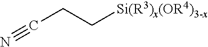

wherein x is preferably 0, and R⁴ is selected from methyl and ethyl, preferably R⁴ is methyl, and
the (meth)acryloxyalkylsilanes are selected from the formula:

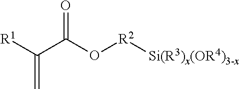

wherein R¹, R², R³ R⁴ and x are as defined above, R² is preferably a 1,3-propane diyl group, particularly preferred is

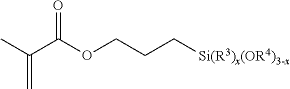

wherein x is preferably 0, and R⁴ is selected from methyl and ethyl, and the mixtures thereof.
6. The composition according to any of the previous embodiments, wherein the phosphine oxide compound is selected from the formula:

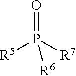

wherein R⁵, R⁶ and R⁷ are selected from optionally substituted aryl groups, linear or branched C1-C10 alkoxy groups, and optionally substituted acyl groups, and where up to one of R⁵, R⁶ and R⁷ can be hydroxy.
7. The composition according to any of the previous embodiments, comprising
   about 30 to about 85 wt.-% of the epoxy resin curing agent (i),
   about 10 to about 50 wt.-% of water and/or diluents, and
   about 0.5 to about 20 wt.-% of the at least one silane component (ii),
   wherein the weight percentages are based on the total amount of the composition.
8. Use of the composition (B) according to any of the previous embodiments as a curing agent for epoxy resins, preferably for water-based epoxy resin compositions.
9. A curable epoxy resin composition comprising at least one epoxy resin and the at least one composition (B) comprising the at least one epoxy resin curing agent, said composition being defined in any of the previous embodiments.
10. The curable epoxy-resin composition according to the previous embodiment, which is an aqueous resin composition.
11. The curable epoxy-resin composition according to any of the previous embodiments, which is selected from a coating composition, a painting composition, an adhesive composition, an encapsulant composition, a sealant composition, and a composite material composition.
12. A kit of parts comprising a first part, a composition (A), comprising at least one epoxy resin, and second part, which is the composition (B), comprising the at least one epoxy resin curing agent (i), as defined in any of the previous embodiments.
13. The curable epoxy resin composition or the kit of parts according to any of the previous embodiments, wherein the epoxy resin curing agent (i) is selected from polyamines, and wherein the molar ratio of the total molar amount of the epoxy groups in the epoxy resin to the total molar amount of the amino groups in the epoxy curing agent (i) is from about 10:1, preferably about 5:1 to 1:1, more preferably about 4:1, and still more preferably 2:1, to about 1:1.
14. A curable epoxy resin composition or the kit of parts according to any of the previous embodiments, comprising:
   about 5 to about 80 wt.-% of the at least one epoxy resin,
   about 5 to about 40 wt.-% of the at least one epoxy curing agent (i),
   about 5 to about 60 wt.-% of water and/or diluents,
   about 0.1 to about 20 wt.-% of the at least one of the silane component (ii),
   wherein the weight percentages are based on the total amount of the composition or the kit of parts.
15. The curable epoxy resin composition or the kit of parts according to any of the previous embodiments, wherein the epoxy resin is a polyepoxide compound.
16. The epoxy resin composition or the kit of parts according to any of the previous embodiments, wherein the composition (A) comprising the at least one epoxy resin comprises at least one kind of inorganic particles such as pigments, fillers and/or extenders, and wherein the composition (B) comprising the at least one epoxy resin curing agent preferably does not contain inorganic particles such as pigments, fillers and/or extenders.
17. The curable epoxy resin composition or the kit of parts according to any of the previous embodiments comprising water.
18. The epoxy resin composition or the kit of parts according to any of the previous embodiments comprising one or more additional binder resins.
19. A process for the manufacture of the curable epoxy resin composition according to any of the previous embodiments comprising the step of admixing the composition (A) comprising the at least one epoxy resin and the composition (B) comprising the at least one epoxy resin curing agent (i) according to any of the previous embodiments.
20. A process according to the previous embodiment, wherein the mixing weight ratio of the epoxy resin composition (A) to the composition (B) is from about 4:1 to about 1:4.
21. An curable epoxy resin composition or the kit of parts according to any of the previous embodiments, comprising one or more additives.
22. Cured epoxy compositions obtained by curing the curable epoxy resin composition according to any of the previous embodiments.
23. Cured epoxy compositions according to the previous embodiment, where the curing is carried out at a temperature in the range of 20 to 100° C.
24. Cured articles, comprising the cured epoxy resin composition as defined in the previous embodiments selected from components for the automotive industry, the construction industry, the marine industry, the aerospace industries, the electronic industry, such as coatings, paints, lacquer, adhesive layers, composites, encapsulants in particular for circuit boards and the like.
25. Cured articles according to the previous embodiments, which are layered materials such as coatings having a thickness in the range of about 1 to about 100 μm, preferably about 55 to about 65 μm.
26. Use of the curable epoxy resin compositions according to the previous embodiments for the manufacture of marine and industrial maintenance coatings, metal container and coil coatings, automotive coatings, inks and resists, adhesive coatings, casting, potting, and encapsulation of electrical-equipment.
27. Curable epoxy resin compositions according to any of the previous embodiments, which are selected from the group consisting of marine coating composition, industrial maintenance coating compositions, metal container and coil coating compositions, automotive coating compositions, inks and resists compositions, adhesive coating compositions, casting compositions, potting compositions, and sealant or encapsulation compositions in particular for electrical equipment.
28. Use of the curable epoxy resin compositions according to any of the previous embodiments to prepare a layer of a multilayer coating.
29. Use of the curable epoxy resin compositions according to any of the previous embodiments for the manufacture of primer layers on metal substrates, in particular steel substrates.
30. Use of at least one silane component (ii), selected from the group consisting of (meth)acrylamidoalkylsilanes, cyanoalkyl silanes and a combination of at least one (meth)acryloxyalkylsilane and at least one phosphine oxide compound as corrosion inhibitor in curable epoxy resin compositions, in particular curable epoxy resin coating compositions.

The present invention will be explained in more detail by the following examples.

### EXAMPLES

(All amounts are indicated as grams unless indicated otherwise).

### Example 1. Formulation of a Water-Based Epoxy Dispersion

Preparation of the polyepoxide part of a two-component water-based coating system was carried out in accordance with the general formulation shown in table. 1. For this, positions 1.-11. were gently charged into the double-jacket mixing vessel equipped with cowles blade dispersion mixer under agitation at 300 rpm. After the charging the resulting mixture was agitated for 30 min at room temperature. Afterwards, the resulting pre-mix was charged with 1 kg of Zr-beads (Ø1.2-1.4 mm) and grinded at 1500 rpm. for 45 minutes. During the mixing and the grinding process the mixing vessel was cooled down to room temperature. After the process was completed the liquid phase of the resulting mixture was separated from the Zr-beads, charged with position 12. and stirred for additional for 15 min. Afterwards, the resulting mixture was collected into the 3 L plastic container and kept for further use.

TABLE 1
Formulation of water-based epoxy dispersion

| | Component | Amount | Function |
|---|---|---|---|
| 1. | Epirez 6520-WH-53¹ | 310.1 | Polyepoxide resin |
| 2. | Water | 105.1 | Solvent |
| 3. | Methoxypropanol | 26.3 | Co-Solvent |
| 4. | CoatOSil 7210 | 0.2 | Silicone-polyether, defoamer |
| 5. | R960 Chemours | 92.0 | Titanium dioxide, pigment |
| 6. | Heucophos schwarz | 13.1 | Copper chromite, pigment |
| 7. | BlancFix | 92.0 | Barium sulphate, extender |
| 8. | Talkum AT | 46.0 | Talkum, filler |
| 9. | Heucophos CAPP | 26.3 | Calcium phosphate, filler |
| 10. | Micaceous iron oxide | 26.3 | Iron oxide, pigment |
| 11. | Trimin 238 EST 600 | 65.7 | Calcium silicate, filler |
| 12. | Epirez 6520-WH-53 | 197.1 | Polyepoxide resin |
| | Total | 1000.0 | |

¹EPI-REZ ™ Resin 6520-WH-53 is a 53% solids, non-ionic aqueous dispersion of a modified EPON ™ Resin 1001 type solid epoxy resin, which is a 2.2-bis(p-glycidyloxyphenyl)propane condensation product with 2.2-bis(p-hydroxyphenyl)propane and similar isomers.

### Comparative Example 2. Formulation of a Water-Based Polyamine Dispersion Crosslinker

The preparation of the polyamine part of a two-component water-based coating system was carried out in accordance with the general formulation shown in the table 2. For this, positions 1.-4. were gently charged into the double-jacket mixing vessel equipped with cowles blade dispersion mixer under agitation at 300 rpm. After the charging the resulting mixture was agitated for 30 min at room temperature. Afterwards, the resulting mixture was filtered and collected into the 3 L plastic container and kept for further use.

TABLE 2
Formulation of water-based polyamine
dispersion dispersion (comparative)

| | Component | Amount | Function |
|---|---|---|---|
| 1. | Epikure 6870-W-53² | 676.9 | Polyamine curing agent |
| 2. | Dowanol PPH | 159.0 | (1-Phenoxy-2-propanol) Co-solvent |
| 3. | Water | 159.0 | Solvent |
| 4. | Rybo 60 | 5.1 | Flash-rust inhibitor |
| | Total | 1000.0 | |

²EPIKURE Curing Agent 6870-W-53 is a 53% solids, non-ionic aqueous dispersion of a modified polyamine adduct curing agent.

### Examples and Comparative Examples 3-12. Formulation of Water-Based Polyamine Dispersion Crosslinker

The preparation of the polyamine parts of a two-component water-based coating system was carried out in accordance with the general formula summarized in the table 3. For this, positions 1.-9. were gently charged into the double-jacket mixing vessel equipped with cowles blade dispersion mixer under agitation at 300 rpm. After the charging the resulting mixture was agitated for 30 min at room temperature. Afterwards, the resulting mixture was filtered and collected into the 3 L plastic container and kept for further use.

TABLE 3
Formulations of water-based polyamine dispersion

| Polyamine formulation | | | | | | | |
|---|---|---|---|---|---|---|---|
| | Component | C.-Ex. 3 | C.-Ex. 4 | Ex. 5 | Ex. 6 | Ex. 7 | C.-Ex. 8 |
| 1. | Epikure 6870-WH-53 | 615.4 | 615.4 | 615.4 | 645.5 | 582.4 | 637.1 |
| 2. | Dowanol PPH | 144.5 | 144.5 | 144.5 | 151.6 | 136.7 | 149.6 |
| 3. | Water | 144.5 | 144.5 | 144.5 | 151.6 | 136.7 | 149.6 |
| 4. | Rybo 60 | 4.7 | 4.7 | 4.7 | 4.9 | 4.4 | 4.8 |
| 5. | Silquest A174³ | 90.9 | — | — | — | 86.0 | — |
| 6. | Silquest Y-9936⁴ | — | 90.9 | — | — | — | — |
| 7. | Silquest A178⁵ | — | — | 90.9 | — | — | — |
| 8. | CETMS⁶ | — | — | — | 46.5 | — | — |
| 9. | Lucirin TPO-L⁷ | — | — | — | — | 53.8 | 58.9 |
| | Total | 1000.0 | 1000.0 | 1000.0 | 1000.0 | 1000.0 | 1000.0 |

| Polyamine formulation | | Ex. 9 | Ex. 10 | Ex. 11 | Ex. 12 |
|---|---|---|---|---|---|
| 1. | Epikure 6870-WH-53 | 582.4 | 582.4 | 525.7 | 582.4 |
| 2. | Dowanol PPH | 136.7 | 136.7 | 123.5 | 136.7 |
| 3. | Water | 136.7 | 136.7 | 123.5 | 136.7 |
| 4. | Rybo 60 | 4.4 | 4.4 | 4 | 4.4 |
| 5. | Silquest A174⁸ | — | — | 77.7 | 86.0 |
| 6. | Silquest Y-9936⁹ | 86.0 | — | | — |
| 7. | Silquest A178¹⁰ | — | 86.0 | | — |
| 8. | Lucirin TPO-L | 53.8 | 53.8 | | — |
| 9 | TPO¹¹ | | | 145.8 | |
| 10 | BEHP¹² | | | | 53.8 |
| | Total | 1000.0 | 1000.0 | 1000.0 | 1000.0 |

C.-Ex.: Comparative Example
Ex.: Inventive Example
³Silquest A-174 gamma-methacryloxypropyltrimethoxysilane: 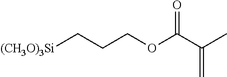
⁴Silquest Y-9936: gamma-methacryloxypropyltriethoxysilane: 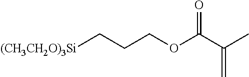
⁵Silquest A178: methacrylamido-silane: 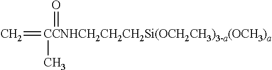
⁶CETMS: 2-(Cyanoethyl)trimethoxysilane: 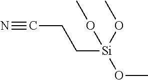
⁷2,4,6-Trimethylbenzoylethoxyphenylphosphine oxide or Ethyl (2,4,6-trimethylbenzoyl)phenylphosphinate: 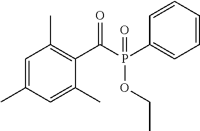 [SMILES: CCOP(=O)(C(=O)c1c(C)cc(C)cc1C)c1ccccc1]
⁸A-174 gamma-methacryloxypropyltrimethoxysilane: 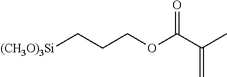
⁹Silquest Y-9936: gamma-methacryloxypropyltriethoxysilane: 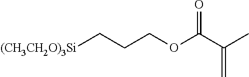
¹⁰Silquest A178: methacrylamido-silane: 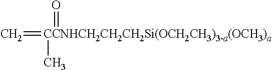
¹¹TPO Diphenyl-(2,4,6-trimethylbenzoyl)phosphinoxide
¹²Bis(2-ethylhexyl)phosphate

### Example 13 Preparation and Application of the Two-Component Water-Based Epoxy Coatings

The preparation of liquid two-component water-based epoxy coatings was carried out by mixing the polyepoxide dispersion from Example 1 with the polyamine curing agent compositions of Examples and Comparative examples 2 to 12 and mechanical stirring of the resulting mixture with the mixing rod for 5 minutes. The mixing ratio of the polyepoxide part and the polyamine part of the formulation always correspond to a molar ratio of the amino groups to the epoxy groups equal to 0,8 in the final mix, which corresponded essentially to a weight ratio of the epoxy resin composition to the curing agent composition of about 32/8. After mixing the resulting paint was transferred into the pneumatic, conventional, manual, gravity feed spray-gun, equipped with the 1.6 mm spray nozzle and set at 1.5-2.0 bar air pressure. The coating system was sprayed over different test substrates (10×10 cm or 10×20 cm size) including cold-rolled steel or CRS (Gardobond OC) and sand-blasted steel (Sa2.5). Before the spraying test the substrates were cleaned by a paper cloth immersed in xylene and then by a paper cloth immersed in isopropyl alcohol. After spraying liquid coating films were dried for 240 h at room temperature. Total dry film thickness of the coated test samples was set to 55 to 65 microns. Wet paint systems described in Examples 1-3 were used either as freshly prepared materials (e.g. used min 24 h and max. 48 h after initial preparation of liquid systems) or as thermo-aged materials (e.g. aged for 1, 2 or 3 months at 50° C. in a laboratory oven).

### Example 14 Tests of Corrosion Resistance and Humidity Resistance Investigation of the Corrosion Resistance

Investigation of the corrosion resistance of the two-component water-based epoxy coating systems was carried out in accordance with the EN ISO 7242 accelerated neutral salt spray test (NSST) specification. For this coated test panels aged for minimum 240 h after spraying were scratched with X scribe (ca. 0.3-0.5 mm wide) through the coating film down to the substrate metallic surface using the scratch-maker pen. Afterwards, panels were taped on the backside and put into the salt spray chamber for 240 h, 504 h and 1008 h respectively. After the exposure the test panels were removed from the salt-spray chamber, cleaned from rust deposits and analyzed in line with the general recommendations of EN ISO 7242 test specification.

### Investigation of the Humidity Resistance

Investigation of the humidity resistance of the two-component water-based epoxy coating systems was carried out in accordance with the DIN EN ISO 6270-2 constant humidity condensed water test. For this, coated test panels aged for minimum 240 h after spraying were put for 24, 48, 120 and 240 h into the humidity cabinet and analyzed after humidity exposure with the cross-hatch adhesion test in accordance with DIN 53151.

### Comparative Example 15. Results of the Corrosion Resistance and Humidity Resistance Test of the Coating System From Example 1 and Comparative Example 2, Freshly Prepared

The results of the corrosion resistance test and the humidity resistance test of the coating system based on polyepoxide pigment dispersion from Example 1 and polyamine crosslinker dispersion from Example 2 are summarized in table 4. Both, the liquid polyepoxide pigment dispersion and the liquid polyamine crosslinker were used as freshly prepared materials.

TABLE 4
Corrosion resistance tests of the epoxy coating system from Example
1 and Comparative Example 2 on cold-rolled steel CRS (comparative)

| | | Max. corrosion | Humidity resistance (Crosshatch) | | | | |
|---|---|---|---|---|---|---|---|
| Comparative | Polyamine | creep at scribe | | wet, | wet, | wet, | wet, |
| Example | formulation | after 240 h NSST | Dry | 24 h | 48 h | 120 h | 240 h |
| 15 | Ex. 2 | delamination | Gt0 | — | Gt5 | — | — |
| | (no silane) | | | | | | |

As shown in table 4 in the corrosion resistance test of the coating system from Example 1 and Example 2 on CRS after 240 h NSST exposure a complete delamination of the coating is observed. In the dry and wet cross-hatch adhesion test complete delamination after 48 h humidity cabinet exposure has been observed.

### Comparative Example 16. Results of the Corrosion Resistance and Humidity Resistance Tests of the Coating System From Example 1 and Comparative Example 2, After Aging for 1 Month at 50° C. (Comparative Example)

The results of the corrosion resistance test and the humidity resistance of the coating system based on the polyepoxide dispersion from Example 1 and polyamine crosslinker dispersion from Comparative Example 2 are summarized in table 5. Both, the liquid polyepoxide pigment dispersion and the liquid polyamine crosslinker were aged (separately) for 1 month at 50° C. before paint application.

TABLE 5
Corrosion resistance tests of the coating system from Example
1 and Example 2 on CRS after aging (comparative)

| | | Max. corrosion | Humidity resistance (Crosshatch) | | | | |
|---|---|---|---|---|---|---|---|
| Comparative | Polyamine | creep at scribe | | wet, | wet, | wet, | wet, |
| Example | formulation | after 240 h NSST | dry | 24 h | 48 h | 120 h | 240 h |
| 16 | C.-Ex. 2 | delamination | Gt0 | — | Gt5 | — | — |
| | (no silane) | | | | | | |

As shown in table 5 in the corrosion resistance test of the coating system from Example 1 and Comparative Example 2 on CRS after 240 h NSST exposure a complete delamination of coating system has been observed.

As further shown in table 5 in the dry and wet cross-hatch adhesion) test complete delamination after 48 h humidity cabinet exposure has been observed.

The results presented in Comparative Examples 15 and 16 demonstrate that standard epoxy coating systems without the silane according to the invention lacks corrosion resistance and humidity resistance when applied as freshly prepared materials or as aged materials.

### Comparative Examples 17. and 18. Results of the Corrosion Resistance and Humidity Resistance Tests of Epoxy Coating Systems From Example 1 and Comparative Examples 3 and 4 (Freshly Prepared)

The results of the corrosion resistance test and humidity resistance test of the coating system based on polyepoxide pigment dispersion from Example 1 and polyamine crosslinker dispersions from Comparative Examples 3 and 4 are summarized in table 6. Both, the liquid polyepoxide pigment dispersions and the liquid polyamine crosslinkers were used as freshly prepared materials.

TABLE 6
Corrosion resistance tests of the coating system from Example
1 and Comparative Examples 3 and 4 on CRS (comparative)

| | | Max. | Max. | | | | | |
|---|---|---|---|---|---|---|---|---|
| | | corrosion | corrosion | | | | | |
| | | creep at | creep at | Humidity resistance (Crosshatch) | | | | |
| Comparative | Polyamine | scribe after | scribe after | | wet, | wet, | wet, | wet, |
| Example | formulation | 240 h NSST | 504 h NSST | Dry | 24 h | 48 h | 120 h | 240 h |
| 17 | C.-Ex. 3 | <5 mm | <7 mm | Gt0 | — | Gt5 | — | — |
| | (Silquest | | | | | | | |
| | A174) | | | | | | | |
| 18 | C.-Ex. 4 | <5 mm | <7 mm | Gt0 | — | Gt5 | — | |
| | (Silquest | | | | | | | |
| | Y-9936) | | | | | | | |

Table 6 shows the results of the corrosion resistance test of the coating system from Example 1 and Comparative Example 3 on CRS after 240 h and 504 h NSST exposure and the results of the wet cross-hatch adhesion test after 48 h.

### Examples 19 and 20. Results of the Corrosion Resistance and Humidity Resistance Tests of the Epoxy Coating Systems From Example 1 and Comparative Examples 3 and 4, After Aging for 1 Month at 50° C. (Comparative)

The results of the corrosion resistance and the humidity resistance tests of the coating systems based on the polyepoxide pigment dispersion from Example 1 and the polyamine crosslinker dispersions from Comparative Examples 3 and 4 are summarized in table 7. Both, the liquid polyepoxide pigment dispersion and the liquid polyamine crosslinker were aged for 1 month at 50° C. before paint application.

TABLE 7
Corrosion resistance of coating system from Example
1 and Comparative Examples 3 and 4 on CRS

| | | Max. | Max. | | | | | |
|---|---|---|---|---|---|---|---|---|
| | | corrosion | corrosion | | | | | |
| | | creep at | creep at | Humidity resistance (Crosshatch) | | | | |
| Comparative | Polyamine | scribe after | scribe after | | wet, | wet, | wet, | wet, |
| Example | formulation | 240 h NSST | 504 h NSST | dry | 24 h | 48 h | 120 h | 240 h |
| 19 | C.-Ex. 3 | <5 mm | delamination | Gt0 | — | Gt5 | — | — |
| | (Silquest | | | | | | | |
| | A174) | | | | | | | |
| 20 | C.-Ex. 4 | <4 mm | delamination | Gt0 | Gt0-1 | Gt5 | — | — |
| | (Silquest | | | | | | | |
| | Y-9936) | | | | | | | |

Table 7 shows the results of the corrosion resistance tests of the coating system from Example 1 and Comparative Examples 3 and 4 on CRS after 240 h and 504 h NSST exposure; and the result of the wet cross-hatch adhesion test after 48 h.

The results presented in Comparative Examples 17 to 20 demonstrate that the incorporation of a methacryloxytrimethoxy or -triethoxy silane into the polyamine dispersion crosslinker allows formulating coating systems with improved corrosion resistance and humidity resistance only if the silane-based polyamine part of the formulation is freshly prepared. In case the silane-based polyamine crosslinker formulation is aged for 1 month at 50° C. corrosion resistance of the coating system drops down significantly. Good humidity resistance after humidity cabinet exposure is not possible when only Silquest A174 methacryloxytrimethoxysilane or Silquest Y-9936 methacryloxytriethoxysilane are utilized.

### Example 21-27. Results of the Corrosion Resistance and Humidity Resistance Tests of the Epoxy Coating System From Example 1 and Examples 5-11, After Aging for 1 Month at 50° C. (Inventive)

The results of the corrosion resistance and humidity resistance tests of the coating systems based on the polyepoxide pigment dispersion from Example 1 and the polyamine crosslinker dispersions from Examples 5-11 are summarized in table 8. Both, the liquid polyepoxide pigment dispersion and the liquid polyamine crosslinker dispersions of Examples 5-11 were used after aging for 1 month at 50° C.

TABLE 8
Corrosion resistance of coating system from Example 1 and Examples 5-10 on CRS

| | | Max. | Max. | | | | | |
|---|---|---|---|---|---|---|---|---|
| | | corrosion | corrosion | | | | | |
| | | creep at scribe | creep at | Humidity resistance (Crosshatch) | | | | |
| | Polyamine | after 240h | scribe after | | wet, | wet, | wet, | wet, |
| Example | formulation | NSST | 504h NSST | dry | 24h | 48h | 120h | 240h |
| 21 | Ex. 5 (Silquest | <3 mm | <5 mm | Gt0 | Gt0 | Gt0 | Gt1-2 | Gt1-2 |
| | A178)¹³ | | | | | | | |
| 22 | Ex. 6 (CETMS)¹⁴ | <5 mm | <7 mm | Gt0 | Gt1-2 | Gt1-2 | Gt2 | Gt1-2 |
| 23 | Ex. 7 (Silquest | <3 mm | <5 mm | Gt0 | — | Gt0 | Gt1 | Gt3-4 |
| | A174/TPO-L) | | | | | | | |
| 24 | Ex. 8 (TPO-L) | <7 mm | delamination | Gt0-1 | Gt3-4 | Gt4-5 | — | — |
| 25 | Ex. 9 (Silquest Y- | <3 mm | <5 mm | Gt0 | Gt1-2 | Gt1-2 | Gt1-2 | Gt3 |
| | 9936/TPO-L) | | | | | | | |
| 26 | Ex. 10 (Silquest | <3 mm | <5 mm | Gt0 | Gt0 | Gt0-1 | Gt0-1 | Gt0-1 |
| | A178/TPO-L) | | | | | | | |
| 27 | Ex. 11 (Silquest | <4 mm | <6 mm | Gt0 | Gt1-2 | — | — | — |
| | A174/TPO) | | | | | | | |

¹³Silquest A178: methacrylamido-silane: 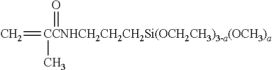
¹⁴CETMS: 2-(Cyanoethyl)trimethoxysilane:

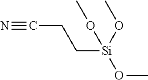

Table 8 shows the results of the corrosion resistance tests of the coating systems from Example 1 and Examples 5-11 on CRS after 240 h and 504 h NSST exposureand results of the dry and wet cross-hatch adhesion test.

The results presented in Examples 21-22 demonstrate that the incorporation of methacrylamidoalkyltrialkoxysilanes or cyanoalkyltrialkoxysilanes into the polyamine dispersion crosslinker allows formulating coating systems with improved corrosion resistance and humidity resistance even after aging of wet paint samples for 1 month at 50° C.

In addition, the results of Examples 23-27 show that the application of olefinically unsaturated methacryloxy- and methacrylamido-trialkoxysilanes in combination with a phosphine oxide compound such as TPO-L (2,4,6-trimethylbenzoylethoxyphenylphosphine oxide) or with TPO (diphenyl-(2,4,6-trimethylbenzoyl)-phosphinoxide) also allows increasing corrosion resistance, humidity resistance and shelf life stability of the wet paint systems.

### Example 20. Results of Storage Stability of Silane-Modified Polyamine Crosslinkers From Example 3, After Aging for 1, 2, and 3 Months at 50° C. (Inventive)

| | Stability of silane-modified polyamine | | |
|---|---|---|---|
| | after aging at 50 C. | | |
| Polyamine formulation | 1 month | 2 months | 3 months |
| C.-Ex. 3 (Silquest A174) | OK | coagulate | coagulate |
| C.-Ex. 4 (Silquest Y-9936) | OK | coagulate | coagulate |
| Ex. 5 (Silquest A178) | OK | OK | OK |
| Ex. 6 (CETMS) | OK | OK | OK |
| Ex. 7 (Silquest A174/TPO-L) | OK | OK | OK |
| Ex. 9 (Silquest Y-9936/TPO-L) | OK | OK | OK |
| Ex. 10 (Silquest A178/TPO-L) | OK | OK | OK |
| Ex. 11 (Silquest A174/TPO) | OK | OK | OK |
| Ex. 12 (Silquest A174/BEHP) | OK | OK | OK |

The results of the storage stability investigation of silane-modified polyamine dispersions demonstrate improved storage stabilities in case of methacrylamidoalkyltrialkoxysilane or cyanoalkyltrialkoxysilane modified systems. In addition, incorporation of a phosphine oxide compound such as TPO-L (2,4,6-trimethylbenzoylethoxyphenylphosphine oxide) or TPO (diphenyl-(2,4,6-trimethylbenzoyl)-phosphinoxide) or bis(2-ethylhexyl)phosphate allows to extending the storage stability of polyamine dispersions also with methacryloxyalkyl trialkoxysilanes.

1. A curable epoxy resin composition comprising at least one epoxy resin and at least one composition (B), said composition (B) comprising (i) at least one epoxy resin curing agent and (ii) at least one silane component selected from the group consisting of (meth)acrylamidoalkylsilanes, cyanoalkylsilanes and a combination of at least one (meth)acryloxyalkylsilane and at least one phosphine oxide compound.

2. The curable epoxy resin composition according to claim 1, wherein the epoxy resin curing agent (i) is selected from the group consisting of polyamines.

3. The curable epoxy resin composition according to claim 1, wherein the composition (B) is substantially free of inorganic particles.

4. The curable epoxy resin composition according to claim 1, wherein
component B includes the (meth)acrylamidoalkylsilanes, and the (meth)acrylamidoalkylsilanes are selected from the formula (I): 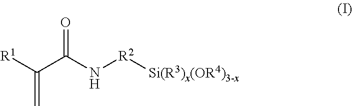
wherein R¹ is H or methyl,
R² is a divalent C1-C6 alkylene group,
R³ is a C1-C6 alkyl group, preferably methyl or ethyl,
R⁴ is a C1-C6 alkyl group, preferably methyl or ethyl,
x is 0 or 1,
and the mixtures thereof.

5. The curable epoxy resin composition according to claim 1, wherein the phosphine oxide compound is selected from the group of compounds represented by formula (II): 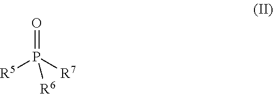
wherein R⁵, R⁶ and R⁷ are selected from optionally substituted aryl groups, linear or branched C1-C10 alkoxy groups, and optionally substituted acyl groups, and
where up to one of R⁵, R⁶ and R⁷ can be hydroxy.

6. The curable epoxy resin composition according to claim 1, wherein the composition (B) comprises:
about 30 to about 85 wt.-% of the epoxy resin curing agent (i),
about 10 to about 50 wt.-% of water or diluents, and
about 0.5 to about 20 wt.-% of the at least one silane component (ii),
wherein the weight percentages are based on the total amount of the composition (B).

7. The curable epoxy-resin composition according to claim 1, which is an aqueous resin composition.

8. A process for the manufacture of thea curable epoxy resin composition of claim 1, which comprises the step of admixing a first part, a composition (A), comprising at least one epoxy resin, and second part, which is the composition (B), comprising the at least one epoxy resin curing agent (i).

9. A method of making the curable epoxy-resin composition of claim 1, comprising combining composition (B) comprising (i) at least one epoxy resin curing agent and (ii) at least one silane component selected from the group consisting of (meth)acrylamidoalkylsilanes, cyanoalkylsilanes and a combination of at least one (meth)acryloxyalkylsilane and at least one phosphine oxide compound.

10. A kit of parts for forming the curable epoxy-resin composition of claim 1, comprising a first part, comprising the composition (A), comprising at least one epoxy resin, and second part, comprising the composition (B), wherein the at least one epoxy resin curing agent (i), is defined in claim 1.

11. The kit of parts according to claim 10, wherein the composition (A) comprising the at least one epoxy resin comprises at least one kind of inorganic particles such as pigments, fillers or extenders, and wherein the composition (B) comprising the at least one epoxy resin curing agent does not contain the inorganic particles.

12. A cured epoxy compositions obtained by curing the curable epoxy resin composition of claim 1.

13. A cured article, comprising the cured epoxy resin composition as defined in claim 1, selected from components for the automotive industry, components for the construction industry, components for the marine industry, components for_the aerospace industries, components for the electronic industry, said components comprising coatings, paints, lacquers, adhesive layers, composites, or encapsulants.

14. A method of using the curable epoxy resin compositions according to claim 1 for the manufacture of marine and industrial maintenance coatings, metal container and coil coatings, automotive coatings, inks, resists, adhesive coatings, castings of electrical-equipment, potting of electrical-equipment, and encapsulation of electrical-equipment.

15. A curable epoxy resin compositions according to claim 1, selected from the group consisting of marine coating compositions, industrial maintenance coating compositions, metal container and coil coating compositions, automotive coating compositions, inks and resists compositions, adhesive coating compositions, casting compositions, potting compositions, sealant compositions or encapsulation compositions.

16. A method of using of at least one silane component (ii) of claim 1, selected from the group consisting of (meth)acrylamidoalkylsilanes, cyanoalkyl silanes and a combination of at least one (meth)acryloxyalkylsilane and at least one phosphine oxide compound as a corrosion inhibitor in the manufacture of curable epoxy resin compositions.

17. The cured article of claim 13, wherein the article is a circuit board.

18. The curable epoxy resin composition according to claim 4, wherein Formula (I) has the structure of Formula (III): 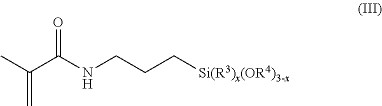
wherein x is 0 or 1, and R⁴ is methyl or ethyl,
and the cyanoalkylsilanes are selected from formula (IV): 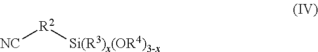
wherein R³ R⁴ and x are as defined above, and R² is a 1,2 ethane diyl group and the mixtures thereof.

19. The curable epoxy resin composition according to claim 18, wherin Formula (IV) has the structure of Formula (V): 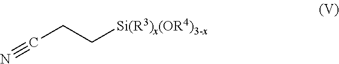
wherein x is 0 or 1, and R⁴ is methyl or ethyl, and
the (meth)acryloxyalkylsilanes are selected from the Formula (VI): 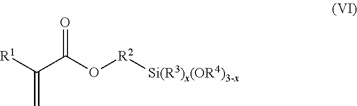
wherein R1, R2, R3 R4 and x are as defined above and the mixtures thereof.

20. The curable epoxy resin composition according to claim 19, wherein R² is a 1,3-propane diyl group.

21. The curable epoxy resin composition according to claim 20, wherein R² is represented by formula (VII): 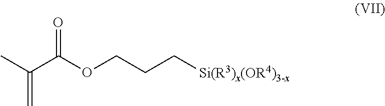
wherein x is O or 1 and R⁴ is methyl or ethyl,
and the mixtures thereof.
